(19) United States
(12) Patent Application Publication
(10) Pub. No.: US 2008/0034305 A1
(43) Pub. Date: Feb. 7, 2008

(54) METHOD FOR PROVIDING FLEXIBLE SELECTION TIME COMPONENTS

(75) Inventors: J. Christopher Hawley, Chelmsford, MA (US); Corinne M. Ryan, Westford, MA (US)

Correspondence Address: CANTOR COLBURN LLP - IBM LOTUS, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/462,074

(22) Filed: Aug. 3, 2006

(51) Int. Cl. G06F 9/00

(52) U.S. Cl. 715/764; 715/963; 715/810; 715/843

(57) ABSTRACT

A method, article, and system for providing electronic scheduling software with an enhanced graphical user interface (GUI) for increasing the flexibility, complexity, and resolution of scheduling options, while minimizing the number of unique independent user selection entries. The enhanced GUI provides flexible time components that offer unique features that will allow the user unprecedented freedom of selection and increased usability. The flexible time components allow the user to visually select unique selections that were difficult to accomplish with past solutions. The user will be notified of the time component's state by a section of the component itself. The state of a time component is the current day that is in the user's focus, a label of the larger logical time the smaller units are in (the current month for the days, the current day for the hours), and how many total selections there are.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to electronic scheduling software, and more particularly to providing a method, article, and system for an enhanced graphical user interface (GUI) for increasing the flexibility, complexity, and resolution of scheduling options, while minimizing the number of unique independent user selection entries.

2. Description of the Related Art

Electronic scheduling programs have become a central feature of modern life and have become quite prevalent in and out of the work environment. For example, during the course of one day of travel, a user may utilize an electronic scheduling application at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day. The widespread use of electronic scheduling applications has increased the demands for improved features, ease of use, and enhanced productivity solutions.

However, currently available electronic scheduling programs only offer cumbersome software interfaces if a user wants to select multiple, flexible durations of time that will apply to the timeline of an activity. For example, a user wishing to schedule a meeting to repeat on Mondays for two months will have to perform fourteen unique independent user selection entries (see FIG. 1) with the IBM Lotus Notes 7 software application. In this instance the GUI is a comprised of a series of pull down menus the user employs to select certain options and/or shortcuts to options by clicking on representative icons with a mouse or other similar selecting or pointing device.

Referring to FIG. 1 the user starts the process of scheduling a meeting at step 100 by clicking the event “New Meeting.” The user then proceeds to select a date, which involves two operations (102, 104). After the meeting date has been established, the user establishes a start and end time for the meeting that involves four user operations (106, 108, 110, 112). In order to establish the meeting as a recurring event, the user is required to open the scheduling dialog repeat box (112), choose monthly repeat (116), choose the repeat day (118), and the duration in steps 120 and 122. Finally the user confirms their selection and closes the repeat dialog box (124) and the meetings are scheduled (126). While completing the action to instruct the scheduling program of the periods of time the user will have office meetings, the user had to select and reselect the same sub component of the main user interface. In the Lotus Notes 7 scheduling application three of the fourteen selections or clicks are wasted opening and re-opening the sub component of the main user interface. The large number of operations can lead to unintended entries and errors. The excessive selections/clicks diminish productivity, and the user becomes frustrated with the scheduling application.

Scheduling a recurring event is another burdensome activity the user has to complete with the existing scheduling software applications. The user has to enter event information through unwieldy interfaces not allowing interactive picking and choosing of actual time. Date picking components are often only visible until a selection is made and then they are hidden from the user's view inhibiting the user from altering their selection. To change their selection the user has to reopen the date-picker and choose only one date again. The user has to establish a begin date and repeat the same process to pick a termination date. With this selected date range, the user has to define a pattern of occurrences when the event repeats within the date range. For example, the user can select a three-week range, with an event every Tuesday within this date range. The existing user interfaces are not flexible enough to allow the user to visually select multiple times.

Selecting time across larger logical units (for instance selecting multiple non-consecutive days across months) is an impossible pursuit—once the user has reached the end of a larger unit (months in this example), the user cannot select any smaller units (days). The construction of the menu interface is a restricting characteristic. There are solutions allowing selections of durations of time. In these solutions the user selections' flexibility and complexity are insufficient. The durations of units can only be in a simple form:

Currently available electronic scheduling software includes Microsoft Outlook, Lotus Notes, Novell GroupWise, and various web applications such as Travelocity, and Orbitz. Each has a variation on scheduling events that relate to time the user indicates. The interfaces vary from limiting the user to making single selections to allowing the user to pick a primitive range of dates. Microsoft Outlook allows multiple selections of days, yet in a very restricting manner that is only effective for small ranges of time.

For creating instances where users will be out of the office, Lotus Notes will have the user open a dialog box and then only a start date and an end date can be chosen. If there are non-contiguous blocks of days where the user will be out of the office (say a sales representative on multiple sales calls, or a doctor making in home consultations), for each new date the dialog box has to be opened again. Current implementations of Out of Office features available in Lotus Notes 7 allow the user to select a start date from one date-picker and an end date from a second date-picker, causing multiple user interactions as detailed in FIG. 1. The present invention enables the user to click on the start date and drag to the end date, thus encompassing the full set of days the user will be Out of the Office, facilitating a decrease in user interaction for the same task, as well as, reducing computing resources as the days out are selected rather than calculated via the known start date and end date in existing implementations.

For creating instances of calendar entries, Lotus Notes and Microsoft Outlook have limited date-pickers that have the ability to display more than one month at a time, where each month is represented by a new instance of the date-picker, but the user can only interact with one date-picker at a time to select a date. The user may not select a time span across the two months with one gesture to create an event.

The present invention is directed to addressing, or at least reducing, the effects of, one or more of the problems set forth above, by giving the user of electronic scheduling programs a means for an enhanced graphical user interface (GUI) for increasing the flexibility, complexity, and resolution of scheduling options, while minimizing the number of unique independent user selection entries.

### SUMMARY OF THE INVENTION

Embodiments of the present invention include a method for a user to schedule multiple and/or repeating events over an extended period of time through the use of flexible selection time components, of an electronic scheduling program, while minimizing the number of unique user operations. The flexible selection time components are provided by an electronic scheduling program in the form of a graphical user interface, wherein the flexible selection time components expand their scheduling field to encompass the desired time range of the multiple events within a single unique user operation. The flexible selection time components represent various gradations of time units. The method of the present invention comprises the user selecting an initial flexible selection time component based on the event to be scheduled. The user continues to select events to be scheduled, within the initial flexible selection time component, where the initial flexible time component expands its scheduling field to accommodate the range of events to be scheduled by the user.

A system for implementing the method of the present invention, as well as, an article comprising one or more machine-readable storage media containing instructions that when executed enable a processor to carry out the method, are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram illustrating how an existing electronic scheduling program user interface would carry out scheduling a meeting to repeat on Mondays for two months.

FIG. 2 illustrates a system for practicing one or more embodiments of the present invention.

FIGS. 3A-3H show exemplary embodiments of flexible time components of the pull down menu user interface for an electronic scheduling application.

FIGS. 4A-4D illustrate the expansion of the flexible time component interface beyond a monthly time unit to schedule an event on eleven consecutive Mondays in one embodiment of the present invention.

FIGS. 5A-5D illustrates the use of flexible time component interface to schedule an event on six consecutive Mondays and Fridays in one embodiment of the present invention.

FIG. 6 is a flow diagram illustrating the use of the flexible time components user interface to carry out scheduling a meeting to repeat on Mondays for two months according to an embodiment of the present invention.

The detailed description explains the preferred embodiments of the invention, together with advantages and features, by way of example with reference to the drawings.

### DETAILED DESCRIPTION OF SPECIFIC EMBODIMENTS

It is the object of the present invention to provide a method and means for decreasing the number of total unique user selections or clicks for a given scheduling activity and to increase the usability of the scheduling software user interface. The present novel invention accomplishes this with time components that offer unique features that will allow the user unprecedented freedom of selection and increased usability. The time components allow the user to visually select unique selections that were difficult to accomplish with past solutions. The user will be notified of the time component's state by a section of the component itself. The state of a time component is the current day that is in the user's focus, a label of the larger logical time the smaller units are in (the current month for the days, the current day for the hours), and how many total selections there are.

The flexible selections offered by the novel time components of the user interface allow for excessive clicks to be minimized. Flexible selections permit the user to select similar times beyond the boundaries of the present selection. In other words, if a user wishes to pick 6 consecutive Mondays starting in the month of March, the month selection will automatically expand to the following month of April. In the same manner, the user can select the first week of consecutive months. Upon the whole week becoming selected, if the user continues outside of the time component's user interface boundaries, the first week of the next month will be selected and so on until the user stops dragging the mouse. The expandable selection area of the time components enables longer-term time selection with a single unique user selection (drag and click). When the user reaches the display boundary of a time component, the time component will expand to the next larger logical time unit (for days the next month is shown, and for years the next decade is shown).

When a user selectable time component interface is located near the boundary of the display screen, for example on the left side of the screen and the user's selection is proceeding in a leftward direction, the time component progresses to the next larger logical time unit. In an alternative embodiment, the time component can be automatically re-centered on the display screen. In yet another embodiment, the user can employ the mouse scroll wheel to advance to the next larger logical time unit (to the next month in a day component).

With the implementation of the flexible time component user interface, users are able to complete their work faster and more efficiently, due to the improved utility of the scheduling interface. By increasing the selection area of the time components temporarily while selections are made, the user is able to select larger durations of time than previously possible. This leads to a reduction of excessive clicking and greater user productivity.

Turning now to the drawings as described in detail below, the present invention provides for an enhanced graphical user interface (GUI) for increasing the flexibility, complexity, and resolution of scheduling options, while minimizing the number of unique independent user selection entries.

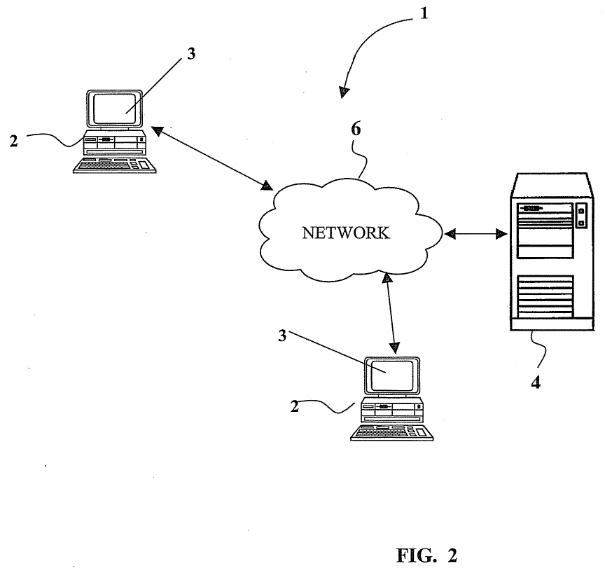

FIG. 2 is a block diagram of an exemplary system 1 for implementing the electronic scheduling program of the present invention and graphically illustrates how those blocks interact in operation. The system includes one or more computing/communication devices 2 coupled to a server system 4 via a network 6. Each computing/communication device 2 may be implemented using a general-purpose computer executing a computer program for carrying out the processes described herein. The computing/communication devices 2 may also be, but are not limited to, portable computing devices, wireless devices, personal digital assistants (PDA), cellular devices, etc. The computer program may be resident on a storage medium local to the computing/communication devices 2, or maybe stored on the server system 4. The server system 4 may belong to a public service provider, or to an individual business entity or private party. The network 6 may be any type of known network including a local area network (LAN), wide area network (WAN), global network (e.g., Internet), intranet, wireless or cellular network, etc. The computing/communication devices 2 may be coupled to the server system 4 through multiple networks (e.g., intranet and Internet) so that not all computing/communication devices 2 are coupled to the server system 4 via the same network. In a preferred embodiment, the network 6 is a LAN and each computing/communication device 2 executes a user interface application (e.g., web browser) to contact the server system 4 through the network 6. Alternatively, a computing/communication device 2 may be implemented using a device programmed primarily for accessing network 6 such as a remote client.

The electronic scheduling program of the present invention provides functionality to the user with the same options for scheduling events, absences, tasks, meetings, etc. as in prior art programs, but also offers additional user functionality through an enhanced graphical user interface (GUI) for increasing the flexibility, complexity, and resolution of scheduling options, while minimizing the number of unique independent user selection entries.

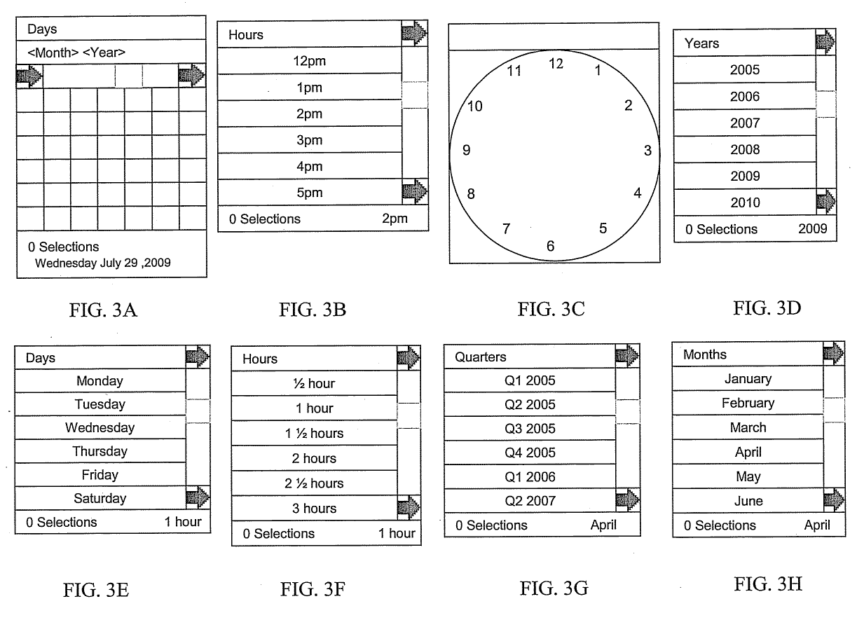

The program of the present invention generates and displays, by well-known software methods, a graphical user interface (GUI) to the user of a computer on which the program is running. Examples of various types of a graphical user interface scheduling selection options (flexible time components) are shown in FIGS. 3A-3H. In the FIG. 2, the graphical user interface of the electronic scheduling program is displayed on the screens 3 of computing/communication devices 2. The flexible time components are presented to the user via a pull down menu that is provided by the GUI to allow the user to select certain options and/or shortcuts to options by clicking on representative icons with a mouse or other similar selecting or pointing device. A pointing device or mouse can also activate the GUI, by hovering over a desired flexible time component label, which brings the full flexible time component into view. In this instance, the menu selection labels are always displayed. It is also possible that the flexible selection time component will always be visible. Alternatively, the host device that comprises the computing/communication device 2 may only support keyboard driven commands to drive the graphical user interface of the present invention. Among the functions provided by the flexible timer components is the ability to control time in various levels of resolution including the selection of years (FIG. 3D), months (FIGS. 3G, 3H), days (FIGS. 3A, 3E), and hours and increments thereof (FIGS. 3B, 3C, 3F).

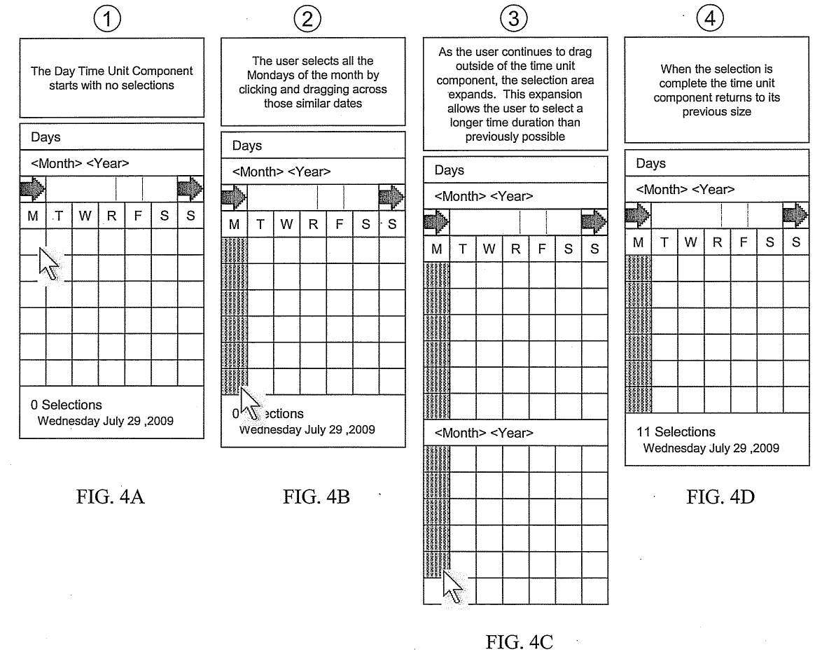

FIGS. 4A-4D illustrate the expansion of the flexible time component interface of FIG. 3A beyond a monthly time unit to schedule an event on eleven consecutive Mondays in one embodiment of the present invention. Initially, the day-time unit component of FIG. 4A starts with no selections. The user proceeds to select all the Mondays of the month by clicking and dragging across those similar dates (FIG. 4B). As the user continues to drag beyond the boundaries of the current time limit, the flexible time component automatically expands (FIG. 4C) to the next logical increment of the current time unit (in this instance months). When the selection of eleven consecutive Mondays is completed the flexible time component reverts to its initial size (FIG. 4D). However, it should be noted that at the bottom portion of the FIG. 4D, eleven selections are now indicated. If one of the selections requires modification, standard selection key modifiers can be used in conjunction with clicking to toggle and extend the selection. An example of this is selecting eleven Mondays to schedule a repeating event, and then deselecting one Monday falling on a business holiday.

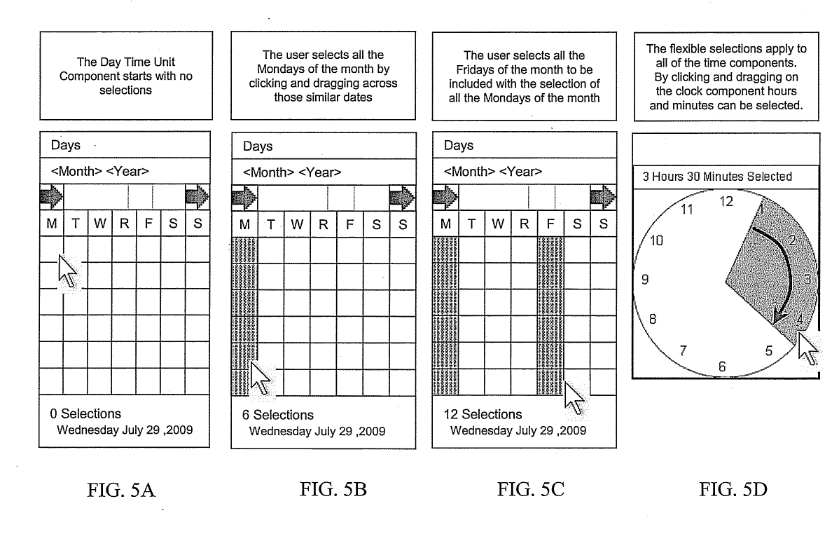

In another example (Please see FIGS. 5A-5D) of the utility and ease of use of the flexible time component interface, a user schedules an event on six consecutive Mondays and Fridays in one embodiment of the present invention. Initially, the day-time unit component of FIG. 5A starts with no selections. The user proceeds to select six consecutive Mondays by clicking and dragging across those similar dates (FIG. 5B). The user then selects the six corresponding Fridays (FIG. 5C). Finally, a time block (3.5 hours) for the twelve selected dates is specified by clicking and dragging on the flexible time component (clock face) of FIG. 3C as shown in FIG. 5D.

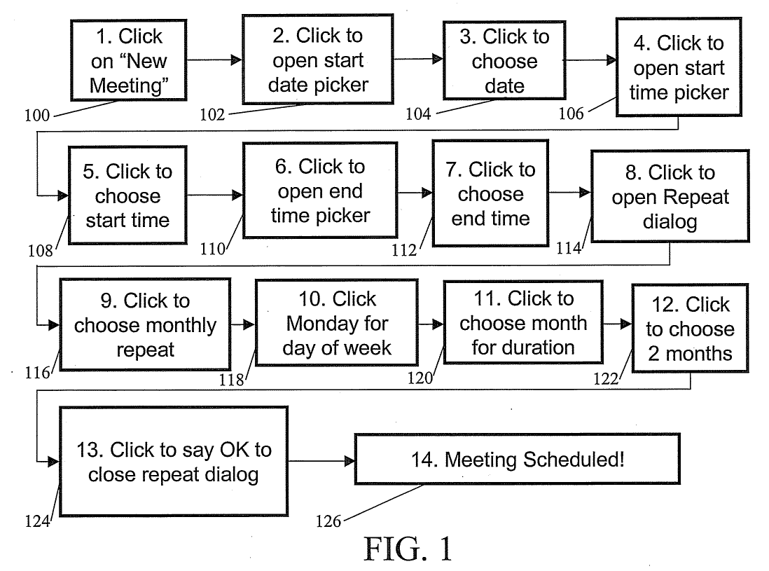

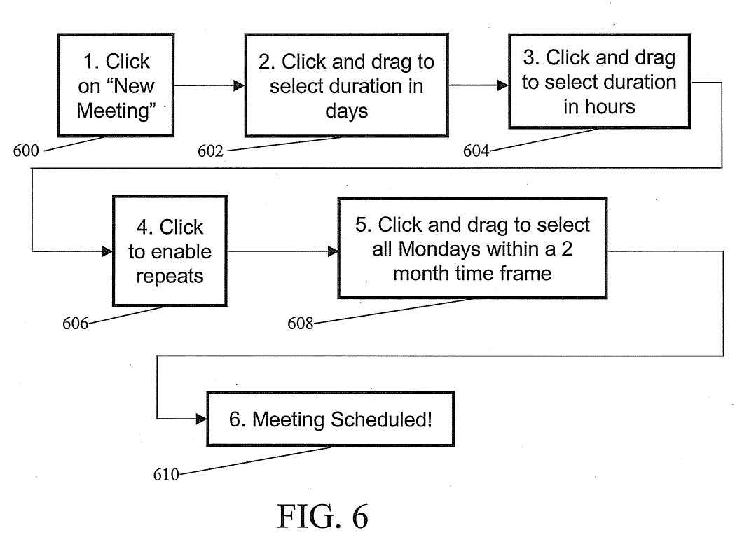

In contrast to flow diagram of FIG. 1, which illustrates how an existing electronic scheduling program user interface would carry out scheduling a meeting to repeat on Mondays for two months with fourteen unique user operations, a current embodiment of the present invention can handle the process in only six steps (please see FIG. 6). Referring to FIG. 6 the user starts the process of scheduling a meeting at step 600 by clicking the event “New Meeting.” The user then proceeds to click and drag, to select a duration in days (602), and click and drag to select a duration in hours (604). The user clicks to enable the repeat function (606), and clicks and drags on the flexible time component of FIG. 3A to select all Mondays within a two-month time frame (608), and schedules the meeting (610). As can be readily seen from a comparison of FIG. 1 and FIG. 6 the flexible time components of the graphical user interface of the current invention greatly streamlines the process of scheduling multiple events over extended periods of time.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for a user to schedule multiple events over an extended period of time through the use of flexible selection time components of an electronic scheduling program while minimizing the number of unique user operations,
wherein said flexible time components are provided by said electronic scheduling program in the form of a graphical user interface; and
wherein said flexible selection time components expand their scheduling field to encompass the desired time range of said multiple events within a single unique user operation; and
wherein said flexible selection time components represent various gradations of time units; said method comprising:
said user selecting an initial flexible selection time component based on the event to be scheduled; and
said user continuing to select events to be scheduled within said initial flexible selection time component, and having said initial flexible time component expand said scheduling field to accommodate the range of events to be scheduled by said user.

2. The method of claim 1 wherein said flexible selection time components further comprise time components that are generated by a pull down menu; and
wherein said user selects said flexible selection time components from said pull down menu.

3. The method of claim 1 wherein said flexible selection time components further comprise gradients of time based on years, months, weeks, days, hours, and minutes; and
wherein said user selects said flexible selection time component appropriate for the event to be scheduled and the time resolution required.

4. The method of claim 3 wherein said flexible selection time component automatically expands to the following day when a user scheduled event extends to the next day when said gradient of time is based on days.

5. The method of claim 3 wherein said flexible selection time component automatically expands to the following week when a user scheduled event extends to the next week when said gradient of time is based on weeks.

6. The method of claim 3 wherein said flexible selection time component automatically expands to the following month when a user scheduled event extends to the next month when said gradient of time is based on months.

7. The method of claim 3 wherein said flexible selection time component automatically expands to the following year when a user scheduled event extends to the next year when said gradient of time is based on years.

8. The method of claim 1 wherein said user selects blocks of time by clicking and dragging a mouse cursor across the desired periods of time; and
wherein said flexible selection time component expands to display additional time periods when said mouse cursor reaches the boundary of said flexible selection time component.

9. The method of claim 1 wherein said user selects blocks of time by employing keyboard driven commands; and
wherein said flexible selection time component expands to display additional time periods when required by said keyboard driven commands when a selection reaches the boundary of said flexible selection time component.

10. The method of claim 1 wherein said multiple events are repeating with a predetermined frequency that the user can define.

11. An article comprising one or more machine-readable storage media containing instructions that when executed enable a processor to access an electronic scheduling program; and
wherein said program enables a user to schedule multiple events over an extended period of time through the use of flexible selection time components of an electronic scheduling program while minimizing the number of unique user operations,
wherein said flexible time components are provided by said electronic scheduling program in the form of a graphical user interface; and
wherein said flexible selection time components expand their scheduling field to encompass the desired time range of said multiple events within a single unique user operation; and
wherein said flexible selection time components represent various gradations of time units.

12. The article of claim 11 wherein said flexible selection time components further comprise time components that are generated by a pull down menu.

13. The article of claim 11 wherein said flexible selection time components further comprise gradients of time based on years, months, weeks, days, hours, and minutes.

14. The article of claim 11 wherein said user selects blocks of time by clicking and dragging a mouse cursor across the desired periods of time; and
wherein said flexible selection time component expands to display additional time periods when said mouse cursor reaches the boundary of said flexible selection time component.

15. The article of claim 11 wherein said user selects blocks of time by employing keyboard driven commands; and
wherein said flexible selection time component expands to display additional time periods when required by said keyboard driven commands when a selection reaches the boundary of said flexible selection time component.

16. A system for a user to schedule multiple events over an extended period of time through the use of flexible selection time components of an electronic scheduling program while minimizing the number of unique user operations, said system comprising:
at least one scheduling device;
a server system;
at least one network; and
wherein said scheduling device is implemented using a general-purpose computer executing said electronic scheduling program; and
wherein said electronic scheduling program is resident on a storage medium local to said scheduling device; and
wherein said scheduling device has the ability to be coupled to said server system via said network; and
wherein said scheduling device has a display means; and
wherein said flexible time components are provided by said electronic scheduling program in the form of a graphical user interface visible on said display means; and
wherein said flexible selection time components expand their scheduling field to encompass the desired time range of said multiple events within a single unique user operation; and
wherein said flexible selection time components represent various gradations of time units.

17. The system of claim 16 wherein said electronic scheduling program is resident on said server system.

18. The system of claim 16 wherein said network may be any type of known network including, but not limited to, a local area network (LAN), wide area network (WAN), Internet, intranet, and wireless networks.

19. The system of claim 16 wherein said scheduling devices are mobile devices with wireless communication capabilities.

20. The system of claim 16 wherein said flexible selection time components are re-centered on said display means when said flexible selection time components expand to the boundary of said display means.
